(19) United States
(12) Patent Application Publication
(10) Pub. No.: US 2009/0066215 A1
(43) Pub. Date: Mar. 12, 2009

(54) PLASMA DISPLAY PANEL AND MANUFACTURING METHOD THEREFOR

(76) Inventor: Tae-Joung Kweon, Suwon-si (KR)

Correspondence Address: CHRISTIE, PARKER & HALE, LLP, PO BOX 7068, PASADENA, CA, 91109-7068, US

(21) Appl. No.: 12/209,119

(22) Filed: Sep. 11, 2008

(30) Foreign Application Priority Data
Sep. 12, 2007 (KR) 10-2007-0092648
Mar. 27, 2008 (KR) 10-2008-0028441

(51) Int. Cl. H01J 63/04; H01J 9/24

(52) U.S. Cl. 313/485; 445/24

(57) ABSTRACT

A plasma display panel includes a front plate and a back plate spaced from and facing each other with a barrier rib therebetween, the front plate and the back plate each having a long side and a short side. A first sealant is at the long side between the front plate and the back plate and a second sealant is at the short side between the front plate and the back plate to seal a discharge space divided by the barrier rib between the front plate and the back plate. A first spacer is in the first sealant and a second spacer is in the second sealant, the second spacer having a smaller volume than the first spacer.

### CROSS-REFERENCE TO RELATED APPLICATIONS

This application claims priority to and the benefit of Korean Patent Applications No. 10-2007-0092648, filed on Sep. 12, 2007, and No. 10-2008-0028441, filed on Mar. 27, 2008, in the Korean Intellectual Property Office, the entire content of which is incorporated herein by reference.

### BACKGROUND

1. Field of the Invention

The present invention relates to a plasma display panel and a manufacturing method thereof.

2. Discussion of Related Art

A plasma display panel (PDP) includes a front plate having X-Y electrodes, a dielectric, and an MgO film formed on a transparent substrate; and a back plate having address electrodes, a dielectric, barrier ribs, and phosphors formed on another substrate. The front plate and the back plate are spaced apart from each other by the barrier ribs. Also, the plasma display panel applies a signal to the address electrodes and the Y electrodes through a mounted control circuit to select discharge cells for light emission. A signal is alternately applied to the X-Y electrodes to display a still image or a moving image. The X-Y electrodes and the address electrodes are driven by the control circuit.

In the case of the above-described plasma display panel, the panel may be bent or otherwise distorted due to the difference in shrinkage rate of the barrier ribs and/or sealant, or an unnecessary gap may be created between the front plate and the back plate of the panel during the process of coupling the back plate to the front plate. The unnecessary gap may lead to an inconsistent distance between the front plate and the back plate of the panel, thereby leading to noise generated in the panel. In particular, a gap formed in a dummy region of the panel after the coupling process of the panel is one of the main sources of noise generation in the panel.

### SUMMARY OF THE INVENTION

Aspects of the present invention provide a plasma display panel capable of reducing noise generated by an inconsistent distance between a front plate and a back plate, and a manufacturing method therefore. Additionally, aspects of the present invention provide a plasma display panel capable of preventing or significantly reducing adverse effects caused by the difference in shrinkage rate of sealant on a long side portion and a short side portion of the panel caused during coupling a back plate to a front plate using the sealant and exhausting it, and a manufacturing method therefore.

One embodiment of the present invention provides for a plasma display panel including a front plate and a back plate spaced from and facing each other with a barrier rib therebetween, the front plate and the back plate each having a long side and a short side. A first sealant is at the long side between the front plate and the back plate and a second sealant is at the short side between the front plate and the back plate to seal a discharge space divided by the barrier rib between the front plate and the back plate. A plurality of first spacers is in the first sealant and a plurality of second spacers is in the second sealant, each of the plurality of second spacers having a smaller volume than a volume of each of the plurality of first spacers.

In one embodiment, a difference between a volume of each first spacer and the volume of each second spacer is less than about 10%. Additionally, the first sealant and the second sealant may include lead-free glass frit and the first sealant may have a greater width than the second sealant.

An electrode array for discharging electricity in the discharge space may be on the front plate and on the back plate, and a phosphor layer emitting the light created by the discharge of electricity is on the back plate. The plasma display panel may further include a groove on at least one of the front plate and the back plate corresponding to an area where the first sealant and the second sealant overlap.

According to another embodiment of the present invention, a method for manufacturing a plasma display panel includes preparing a first sealant by adding a first spacer to a raw sealant and preparing a second sealant by adding a second spacer to the raw sealant, the second spacer having a smaller volume than the first spacer. The method further includes applying the first sealant to a long side portion of a front plate and applying the second sealant to a short side portion of the front plate and aligning the front plate and a back plate and coupling the front plate to the back plate.

According to another embodiment of the present invention, a method for manufacturing a plasma display panel includes preparing a first sealant by adding a first spacer to a raw sealant and preparing a second sealant by adding a second spacer to the raw sealant, the second spacer having a smaller volume than the first spacer. The method may further include preparing a front plate and a back plate each having a long side and a short side, the front plate and the back plate spaced from and facing each other with a barrier rib therebetween, forming a groove in at least one of the front plate and the back plate corresponding to an area where the first sealant and the second sealant overlap, applying the first sealant to the long side of at least one of the front plate and the back plate and applying the second sealant to the short side of at least one of the front plate and the back plate, and aligning and coupling the front plate to the back plate.

### BRIEF DESCRIPTION OF THE DRAWINGS

These and/or other embodiments and features of the invention will become apparent and more readily appreciated from the following description of certain embodiments, taken in conjunction with the accompanying drawings of which:

FIG. 1 is an exploded perspective view showing a plasma display panel according to one embodiment of the present invention.

FIG. 2 is a cross-sectional view in a long-side direction of a plasma display panel according to a comparative example.

FIG. 3A is a plan view showing a configuration before the process of sealing the plasma display panel according to one embodiment of the present invention.

FIG. 3B is a plan view showing a configuration after the process of sealing the plasma display panel according to one comparative example.

FIG. 4A is a partial cross-sectional view in a long-side direction of the plasma display panel according to one embodiment of the present invention.

FIG. 4B is a partial cross-sectional view in a short-side direction of the plasma display panel according to one embodiment of the present invention.

FIG. 5A is a cross-sectional view showing a plasma display panel.

FIGS. 5B and 5C are a cross-sectional view and a plan view of a plasma display panel according to an embodiment of the present invention.

FIG. 6A is a graph showing the results of measuring the noise of the plasma display panel according to the comparative example.

FIG. 6B is a graph showing the results of measuring the noise of the plasma display panel according to one embodiment of the present invention.

### DETAILED DESCRIPTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the element or be indirectly on the element with one or more intervening elements interposed therebetween. Hereinafter, like reference numerals refer to like elements.

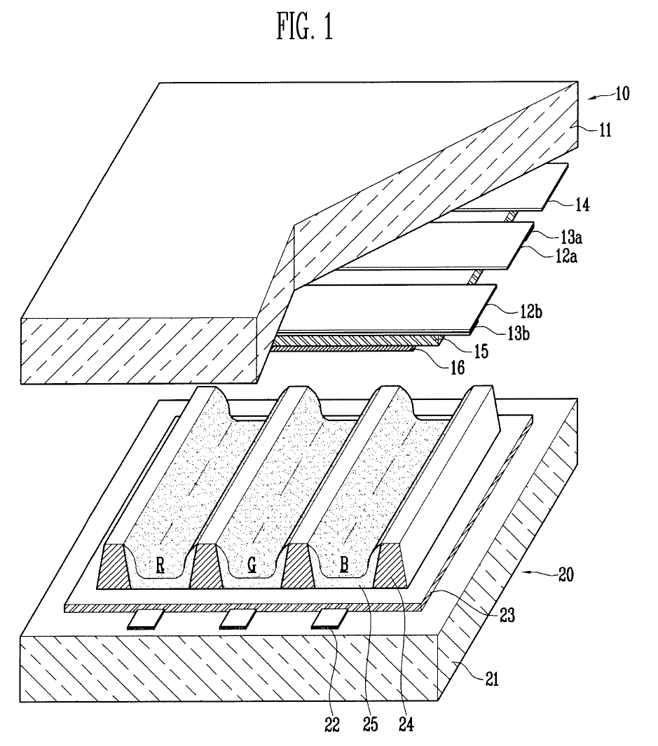

FIG. 1 is an exploded perspective view showing a PDP according to one embodiment of the present invention.

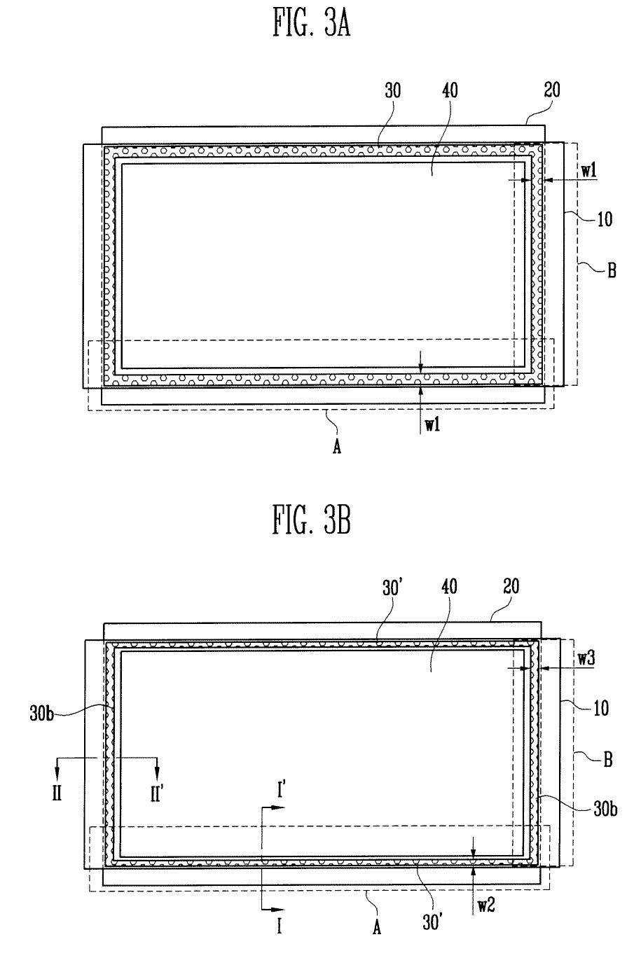

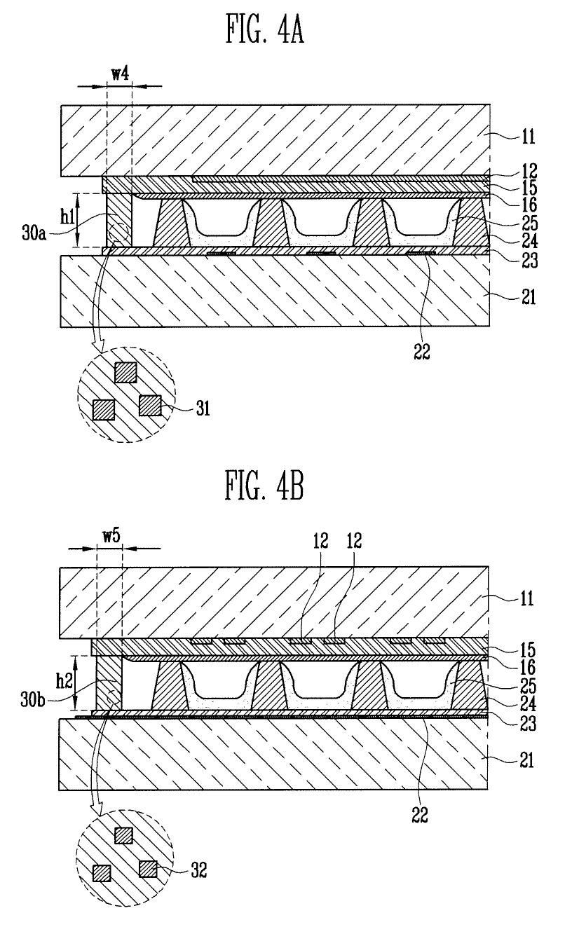

Referring to FIG. 1, the PDP includes a front plate 10 and a back plate 20 facing each other. The front plate 10 includes transparent electrodes 12a, 12b, bus electrodes 13a, 13b, a black layer 14, a first dielectric layer 15, and a passivation layer 16, all of which are formed on a transparent first substrate 11. The back plate 20 includes address electrodes 22, a second dielectric layer 23, barrier ribs 24, and phosphor layers 25, all of which are formed on a second substrate 21. The PDP also includes a sealant (e.g., 30a, 30b; FIG. 3B) for coupling the back plate 20 to the front plate 10; and spacers (e.g., 31, 32; FIGS. 4A, 4B, respectively) mixed within the sealant.

The PDP according to this embodiment may include spacers with different sizes provided according to the position of the sealant (i.e., whether the sealant coats a long side or a short side of the PDP) to prevent or significantly reduce an inconsistent distance between the front plate 10 and the back plate 20 caused by the difference in shrinkage rate of the sealant during the coupling process of the panel. Also, the PDP according to embodiments of the present invention may include a substrate with a groove to prevent or significantly reduce an inconsistent height of the PDP that may occur in an overlapping area of the sealants, such as at the corners of the PDP. The sealant and the spacers will be described in detail, as follows.

More particularly, components of the panel are described in more detail. The transparent electrodes 12a, 12b are electrodes for generating electrical discharges and sustaining the electrical discharges. The transparent electrodes 12a, 12b are formed of transparent materials having a high visible light transmittance. For example, the transparent electrodes 12a, 12b may be formed of ITO, SnO₂, ZnO, CdSnO, among other materials.

The bus electrodes 13a, 13b are electrodes for compensating for a high resistance value of the transparent electrodes 12a, 12b, and are usually a narrower width than the transparent electrodes 12a, 12b. The bus electrodes 13a, 13b are made of materials that have a low electrical resistance and do not react with the first dielectric layer 15. Gold (Au), silver (Ag) and the like may be used as the material of the bus electrodes 13a, 13b.

One transparent electrode 12a and one bus electrode 13a and another transparent electrode 12b and another bus electrode 13b form an X-Y electrode pair (hereinafter, referred to as an X-Y electrode).

The black layer 14 is disposed between a first X-Y electrode and a second X-Y electrode adjacent to the first X-Y electrode to improve contrast. The black layer 14 is formed of materials having a very low visible light transmittance and a high external light absorption rate.

The first dielectric layer 15 functions to limit a discharge current, to sustain a glow discharge, and to accumulate a wall charges. The first dielectric layer 15 may be formed of materials having a high withstanding voltage and a high visible light transmittance. Material such as PbO—B₂O₃—SiO₂ or Bi₂O₃ and the like may be used as the materials of the first dielectric layer 15. The first dielectric layer 15 in one embodiment is formed in a bi-layered structure to have a uniform surface and a thickness greater than a reference thickness. The first dielectric layer in other embodiments may be formed with a structure of a single layer, or multiple layers such as three layers or more using a printing technique.

The passivation layer 16 is disposed on the first dielectric layer 15 to prevent the first dielectric layer 15 from ion bombardment and increase a secondary electron emission coefficient. The passivation layer 16 may be formed of materials having a high visible light transmittance, a high surface insulating property and an excellent resistance to ions sputtering, using a thin film deposition technique. MgO and the like may be used as the material of the passivation layer 16.

The address electrodes 22 are electrodes for selecting discharge cells, and are disposed on the second substrate 21 in a stripe shape. The stripe shape of the address electrodes 22 may extend to cross at a right angle with the transparent electrodes 12a, 12b. The address electrodes 22 are formed of materials, for example, gold (Au), silver (Ag) and the like, having a high electrical conductivity using a printing technique.

The second dielectric layer 23 is disposed on the second substrate 21 to protect the address electrode 22 and give dielectric breakdown strength. The second dielectric layer 23 may be formed of materials having a high light reflectance, or stained with materials having a high light reflectance. PbO, SiO₂, B₂O₃ and the like may be used as the material of the second dielectric layer 23.

The barrier ribs 24 function to enhance color purity by preventing a discharge cell region from spreading along a longitudinal direction of the transparent electrodes 12a, 12b and preventing undesired color mixing of visible light. The barrier ribs 24 are installed to have sufficient strength to support the front plate 10. In order to form a larger number of discharge spacers in a limited region, in one embodiment, the narrower barrier ribs 24 have widths and suitably higher heights. Also, the barrier ribs 24 may be formed of materials having a compact structure so as to suppress absorption of organic matters by phosphor paste. PbO, SiO₂, B₂O₃ and the like may be used as the materials of the barrier ribs 24.

The phosphor layers 25 convert ultraviolet rays, generated through the discharge of electricity, to visible light to emit the visible light. The phosphor layer 25 is formed of materials having an excellent light conversion efficiency and an excellent color purity. The phosphor layers 25 includes a red phosphor layer (R), a green phosphor layer (G), and a blue phosphor layer (B).

A method for manufacturing the above-mentioned PDP according to one embodiment of the present invention will be described briefly, as follows.

First, a metal film for the X-Y electrodes and a black layer 14 are formed on a transparent substrate 11, and a dielectric is printed onto the metal film for the X-Y electrodes and the black layer 14. Then, a passivation layer 16 is formed on the dielectric layer 15 through deposition of an MgO thin film. A front plate 10 is prepared according to the above process.

Next, a metal film for the address electrodes 22 is applied onto another substrate 21 and patterned, and a dielectric is printed on the metal film. The dielectric is printed onto the dielectric layer 23 and a barrier ribs 24 are then formed on the dielectric using a sand blast process. Then, a phosphor layer 25 is formed inside the discharge space divided by the barrier ribs 24. A back plate 20 is prepared according to the above process.

Next, a sealant is applied onto the dielectric layer of the prepared front plate 10 or back plate 20, and sintered. The front plate 10 and the back plate 20 are aligned, fixed, and then sintered at a suitable temperature (e.g., predetermined temperature) to couple the front plate 10 to the back plate 20. Then, a discharge space between the coupled front plate 10 and the back plate 20 is exhausted under a vacuum condition, a mixed gas is introduced into the discharge space at about 500 Torr, and the space is sealed.

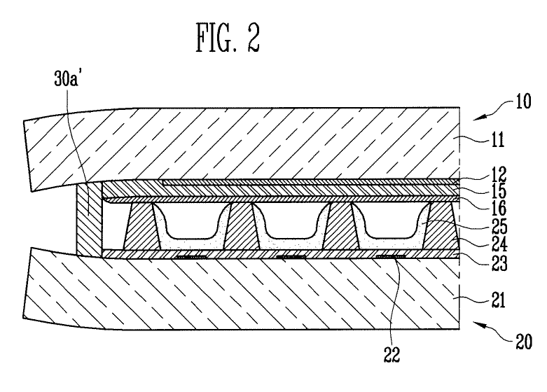

With reference to FIG. 2, a sealant 30a′ arranged in the long side portion of the panel shrinks to a greater degree during sealing of the plates than a sealant arranged in the short side portion of the panel. For example, the first sealant arranged in the long side portion may shrink more than about twice the second sealant arranged in the short side portion if the first and second sealants are formed of the same materials because a length of the first sealant is about eight times greater than the second sealant and their cross-sections are the same. As a result, the front plate 10 and/or the back plate 20 may be bent, or an undesirable gap may occur between the front plate 10 and the back plate 20. Here, the undesirable gap corresponds to a difference in heights between the sealant arranged in the short side portion (e.g., lateral side) and the sealant 30a′ arranged in the long side portion (e.g., longitudinal side). This gap is one of the main causes of noise in the panel.

In general, for the method for manufacturing a PDP according to embodiments of the present invention, a sealant applied to the long side portion of the panel and a sealant applied to the short side portion are independently prepared, taking into account the difference in the shrinkage rate of the sealant that occurs after the above-mentioned sealing process. Therefore, a constant height of the sealant may be maintained in spite of the difference in the shrinkage rate of the sealant by applying the sealants differentially according to the positions of the panel. The coupling process of the front plate and the back plate according to embodiments of the present invention, will be described in more detail as follows.

FIG. 3A is a plan view showing a configuration before a process of sealing the PDP according to one exemplary embodiment of the present invention. FIG. 3B is a plan view showing a configuration after the process of sealing the plasma display panel according to one comparative example. FIG. 4A is a partial cross-sectional view in a long-side direction of the PDP according to one exemplary embodiment of the present invention, and FIG. 4B is a partial cross-sectional view in a short-side direction according to one exemplary embodiment of the present invention, The partial cross-sectional view shown in FIG. 4A may correspond a cross-sectional taken along the line I-I′ of the PDP as shown in FIG. 3B, and the partial cross-sectional view shown in FIG. 4B may correspond a cross-sectional view taken along line II-II′ of the PDP as shown in FIG. 3B.

As shown in FIG. 3A, the coupling process of the PDP includes applying the sealant 30 to the front plate 10 or the back plate 20, aligning the front plate 10 and the back plate 20, and coupling the front plate to the back plate, and performing exhaust and introduction of gas. The widths w1 of the first sealant arranged in the long side portion and the second sealant arranged in the short side portion are substantially the same.

At this time, considering that the sealant of the long side portion may shrink more than the sealant of the short side portion due to the difference in the shrinkage rate of the sealants applied respectively to the long side portion and the short side portion of the panel in this embodiment, when the sealant 30 is applied, a first sealant having a relatively higher spacer volume mixed therein is applied to the long side portion of the front plate 10 or the back plate 20, and a second sealant having a relatively lower spacer volume mixed therein is applied to the cross-section. In a rectangular display screen of the PDP, the long side portion represents a side having a longer length and the short side portion represents a side having a shorter length.

In the meantime, for the PDP coupled by the sintering process, the longer sealant 30′ shrinks more than the shorter second sealant 30b, as shown in FIG. 3B. Therefore, the width w2 of the first sealant 30′ is less than the width w3 of the second sealant 30b.

However, as shown in FIGS. 4A and 4B, in this embodiment, the height h1 of the first sealant 30a arranged in the long side portion A may be substantially identical to the height h2 of the second sealant 30b arranged in the short side portion B and/or the width w4 of the first sealant 30a arranged in the long side portion A may be substantially identical to the width w5 of the second sealant 30b arranged in the short side portion B since a volume of a first spacer 31 included in the first sealant 30a is greater than a volume of a second spacer 32 included in the second sealant 30b. Therefore, according to an embodiment of the present invention, it is possible to prevent or significantly reduce the formation of the gap between the front plate 10 and the back plate 20 after the coupling process.

The volumes of the first spacer 31 and the second spacer 32 may be suitably adjusted according to the characteristics of the coupling frit materials and the size of the panel. However, the volumes of the spacers may be set to different ranges according to the experiential difference in the shrinkage rate of the first sealant 30a of the long side portion A and the second sealant 30b of the short side portion B. For example, in one exemplary embodiment, a volume of the first spacer 31 is set to a value that is about 10% greater than a volume of the second spacer 32. Additionally, the first spacer 31 incorporated into the first sealant 30a may be set to a content of about 0.05 to 2 wt % of the sealant, considering that the maximum difference in the volumes of the first spacer and the second spacer is about 10%, and the second spacer 32 incorporated into the second sealant 30b is also set to a content of about 0.05 to 2 wt % of the sealant.

As described above, for the method for manufacturing a PDP, the first sealant 30a is disposed in the long side portion A having a relatively greater shrinkage rate, the first sealant 30a being obtained by mixing the relatively larger first spacer 31 with the raw sealant. Moreover, the second sealant 30b is disposed in the short side portion B having a relatively lower shrinkage rate, the second sealant 30b being obtained by mixing the relatively smaller second spacer 32 with the raw sealant. Therefore, the height h1 of the first sealant 30a of the long side portion A may be substantially identical to the height h2 of the second sealant 30b of the short side portion B to compensate for the difference in the shrinkage rates of the first sealant 30a and the second sealant 30b.

As described above, for the manufacturing of the PDP, spacers that function as cushions are added and mixed with frit paste. More specifically, spacers having different particle sizes are added to the long side portion and the short side portion to take into account the different shrinkage rates of the barrier ribs and/or the sealants of the long side portion and the short side portion of the panel. As a result, it is possible to prevent or significantly reduce the generation of gaps between the front plate 10 and the back plate 20 during the process of sintering frit, coupling a back plate to a front plate using a sealant such as frit, and exhausting gas from the space formed between the plates.

In another embodiment, a spacer having the same particle size is disposed in the first sealant of the long side portion and the second sealant of the short side portion. However, for the above-mentioned method, the front plate and/or the back plate may be bent, or an inconsistent distance between the front plate and the back plate may be formed since the height (h2) of the sealant (30a′) in the long side portion is shorter than the height (h1) of the sealant in the short side portion due to the difference in the shrinkage rates of the long side portion and the short side portion, similarly as shown in FIG. 2. Accordingly, the method using the spacer having the same particle size may not effectively prevent noise.

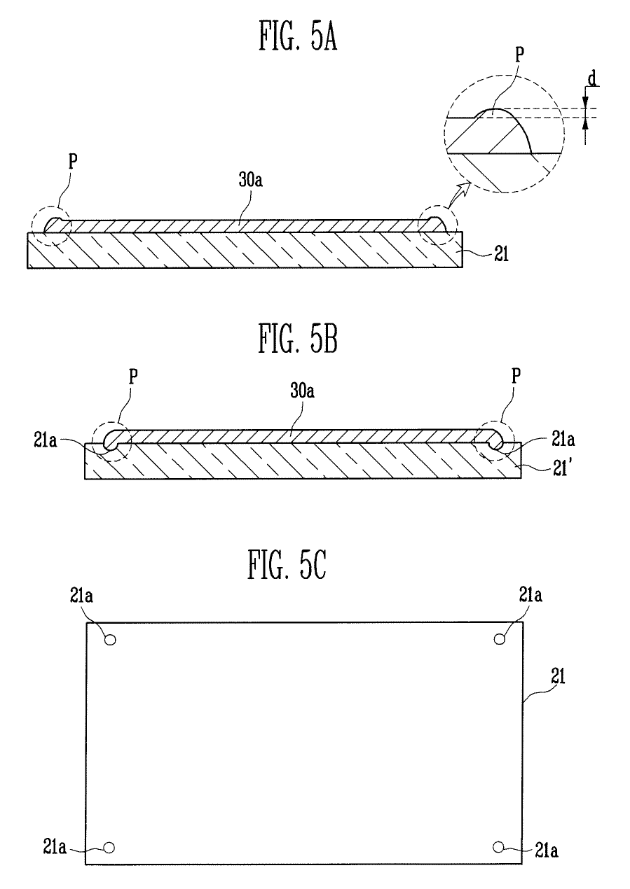

FIG. 5A is a cross-sectional view showing a plasma display panel. FIG. 5B is a cross-sectional view showing a PDP according to other embodiments of the present invention and FIG. 5C is a plan view of the PDP of FIG. 5B.

As noted above, a first sealant 30a disposed in a long side portion of the panel and a second sealant 30b disposed in a short side portion of the panel may not be uniform in height in their overlapping area P, as shown in FIG. 3B.

With reference now to a rectangular panel shown in FIG. 5A, the overlapping area P is formed on each of four corners where two long side portions A of the panel and two short side portions B meet. Here, the overlapping area P is formed by the first sealant 30a and the second sealant 30b meeting at a corner, and accordingly it has a greater height by a certain amount d than the first sealant 30a and the second sealant 30b. This inconsistent height may result in the panel generating noise.

In manufacturing a PDP, if it is possible to control the height of the overlapping area P uniformly when using the first sealant 30a and second sealant 30b including spacers with different sizes to maintain a consistent height of the sealants, additional processes or steps are not required. In the practical process, however, it is not easy to control the height of the overlapping area P uniformly and to seal the panel securely at the same time when using the first sealant 30a and the second sealant 30b having spacers of different sizes. Thus, in the present embodiment, a groove is formed on a portion of the front or back plate of a glass substrate corresponding to the overlapping area P so that the first and second sealants including the overlapping area P are substantially uniform in overall height.

Specifically, in the present illustrative embodiment with reference to FIG. 5B, a groove 21a is formed on the front or back plate 21′ of the panel so that the overlapping area P has a uniform height. In one embodiment as shown in FIG. 5C, the groove 21a may be disposed on each of four corners of the panel. The groove 21a may be formed by a variety of methods such as grinding or the like. The groove 21a may have various shapes and depths properly selected in consideration of the final height or area of the sealants and/or the size or height of the overlapping area P.

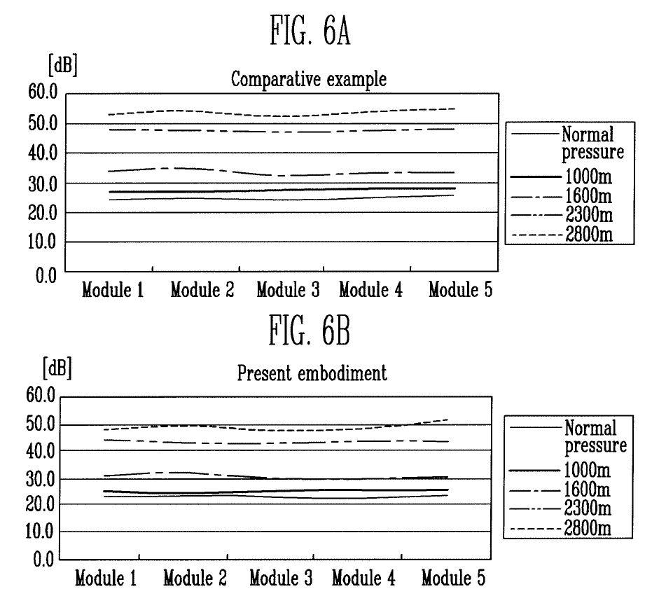

FIG. 6A is a graph showing the results of measuring the noise of the PDP according to a comparative example. FIG. 6B is a graph showing the results of measuring the noise of the PDP according to one exemplary embodiment of the present invention.

In the present experiment, noise from five comparative modules and five modules according to the present embodiment is measured at normal pressure (i.e., atmospheric pressure at sea level), 1000 m, 1600 m, 2300 m, and 2800 m, respectively. Here, it is noted that 1000 m is defined as the pressure of air at 1000 meters above the sea level, and similarly the other numbers indicate the pressure of air at their respective distances above sea level.

In the graphs for the comparative PDPs illustrated in FIG. 6A, module 1, module 2, module 3, module 4, and module 5 generate noise of about 24-26 dB at normal pressure, about 28-29 dB at 1000 m, about 32-36 dB at 1600 m, about 48-49 dB at 2300 m, and about 52-55 dB at 2800 m, respectively.

Meanwhile, in the PDPs according to the present embodiment illustrated in FIG. 6B, module 1, module 2, module 3, module 4, and module 5 generate a noise of about 22-23 dB at normal pressure, about 25-26 dB at 1000 m, about 30-32 dB at 1600 m, about 42-43 dB at 2300 m, and about 48-51 dB at 2800 m, respectively.

In the present embodiment, a groove may be formed in an area of the glass substrate where the frits of the long side portions of the panel and the frits of the short side portions overlap with each other, thereby allowing not only the heights of the long side portions and the short side portions but the height of the overlapping areas thereof to be substantially uniform. Accordingly, noises due to inconsistent heights between the front plate and the back plate in manufacturing the PDP may be effectively prevented or significantly reduced.

As described above, the method for manufacturing a PDP according to embodiments of the present invention may be useful to reduce noise due to the undesirable gap between the front plate and the back plate and thereby improve the quality of the panel by maintaining a constant distance between the front plate and the back plate.

Although embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A plasma display panel comprising:
a front plate and a back plate spaced from and facing each other with a barrier rib therebetween, the front plate and the back plate each having a long side and a short side;
a first sealant at the long side between the front plate and the back plate and a second sealant at the short side between the front plate and the back plate to seal a discharge space divided by the barrier rib between the front plate and the back plate;
a plurality of first spacers in the first sealant; and
a plurality of second spacers in the second sealant, each of the plurality of second spacers having a smaller volume than a volume of each of the plurality of first spacers.

2. The plasma display panel according to claim 1, wherein a difference between the volume of the plurality of first spacers and the volume of the plurality of second spacers is less than about 10%.

3. The plasma display panel according to claim 1, wherein the first sealant and the second sealant comprise lead-free glass frit.

4. The plasma display panel according to claim 1, wherein the first sealant has a greater width than the second sealant.

5. The plasma display panel according to claim 1, wherein an electrode array for generating electrical discharges in a discharge space is on the front plate and on the back plate, and
a phosphor layer for emitting light created by the electrical discharges on the back plate.

6. The plasma display panel according to claim 1, further comprising a groove on at least one of the front plate or the back plate at an area where the first sealant and the second sealant overlap.

7. A method for manufacturing a plasma display panel, the method comprising:
preparing a first sealant by adding a plurality of first spacers to a first amount of a raw sealant;
preparing a second sealant by adding a plurality of second spacers to a second amount of the raw sealant, each of the plurality of second spacers having a smaller volume than a volume of each of the plurality of first spacers;
applying the first sealant to a long side of a front plate and applying the second sealant to a short side of the front plate; and
aligning the front plate and a back plate and coupling the front plate to the back plate.

8. The method for manufacturing a plasma display panel according to claim 7, wherein a difference in the volume of each of the plurality of first spacers and the volume of each of the plurality of second spacers is less than about 10%.

9. The method for manufacturing a plasma display panel according to claim 7, wherein the raw sealant comprises lead-free glass frit.

10. A method for manufacturing a plasma display panel, the method comprising:
preparing a first sealant by adding a plurality of first spacers to a first amount of a raw sealant;
preparing a second sealant by adding a plurality of second spacers to a second amount of the raw sealant, each of the plurality of second spacers having a smaller volume than a volume of each of plurality of first spacers;
preparing a front plate and a back plate each having a long side and a short side, the front plate and the back plate spaced from and facing each other with a barrier rib therebetween;
forming a groove in at least one of the front plate or the back plate at an area where the first sealant and the second sealant overlap;
applying the first sealant to the long side of at least one of the front plate or the back plate and applying the second sealant to the short side of at least one of the front plate or the back plate; and
aligning and coupling the front plate to the back plate.

11. The method for manufacturing a plasma display panel according to claim 10, wherein the volume of each of the plurality of first spacers is greater than the volume of each of the plurality of second spacers by about 10% or less.

12. The method for manufacturing a plasma display panel according to claim 10, wherein the raw sealant comprises lead-free glass frit.
